(19) United States
(12) Patent Application Publication
(10) Pub. No.: US 2025/0064262 A1
(43) Pub. Date: Feb. 27, 2025

(54) Gyroscopic Grinder

(71) Applicant: BUD GRINDER-YO CORP., Vancouver (CA)

(72) Inventor: Randal Stiefel, Vancouver (CA)

(21) Appl. No.: 18/812,206

(22) Filed: Aug. 22, 2024

Related U.S. Application Data
(60) Provisional application No. 63/534,284, filed on Aug. 23, 2023.

(30) Foreign Application Priority Data
May 9, 2024 (CA) 3,237,944

(51) Int. Cl. A47J 42/34; A63H 1/30

(52) U.S. Cl. CPC A47J 42/34; A63H 1/30

(57) ABSTRACT

Embodiments of the disclosure relate to a device including a first hollow body, a second hollow body, and a first hollow axle joining the first hollow body and the second hollow body. The device further includes a second axle coaxial with, and in slip-fit engagement with, the first hollow axle, a first flywheel connected to the solid axle and placed in the first hollow body, and a second flywheel connected to the solid axle and placed in the second hollow body. The device is one of a grinder and a climbing top. A method for operation of the grinder including a detachable lid and coupled to a string is also disclosed herein.

### CROSS-REFERENCE TO RELATED APPLICATIONS

This application claims priority to U.S. provisional application Ser. No. 63/534,284, filed 2023 Aug. 23.

### TECHNICAL FIELD

The disclosure relates to user-manipulated devices including toys and grinders.

### BACKGROUND

A yo-yo is an article of manufacture that employs the principles of a gyroscope to operate, for example, as a toy. A yo-yo includes two bodies (sometimes called sides) with rotational symmetry rigidly connected to each other by an axle. Each body is usually of unitary construction in plastic, metal, or wood. The axle is affixed at the center and inside of each body and maybe a pin or dowel. The bodies are spaced apart along the principal dimension of the axle. A tether or string passes between the bodies and is attached at a first or fixed end at the axle. The string encircles the axle. The second or free end of the string is usually tied to create a loop into which a user may place a finger.

In operation, the string is wound around the axle. The user drops or throws the yo-yo while holding the free end of the string. The yo-yo will spin as it moves away from the user's hand because of the tension on the string. The yo-yo gains rotational momentum. Once the string is unwound there are different behaviours. The yo-yo may “sleep” at the end of the string whereby the yo-yo's spins in the string. A sleeping yo-yo is also often used to perform tricks. The user may induce further tension on the string with a tug. Or alternatively when the yo-yo fully unwinds an impulse counteracting the linear momentum provides the tug. After the tug, the string winds on the axle and the yo-yo climbs the string. For example, returning to the user's hand.

### SUMMARY

This section is intended to introduce certain objectives and aspects of the present disclosure in a simplified manner. The disclosure relates a device a first hollow body, a second hollow body, a first hollow axle joining the first hollow body and the second hollow body, a second axle coaxial with and in slip-fit engagement with the first hollow axle, a first flywheel connected to the solid axle and placed in the first hollow body, and a second flywheel connected to the solid axle and placed in the second hollow body.

In some embodiments, the device is a grinder. In another embodiment, the device is a climbing top.

The disclosure also comprises a method for operation of a grinder including a detachable lid and coupled to a string. The method comprises loading an input material into the grinder, attaching the detachable lid, throwing the grinder while holding the string, tugging on the string, and stopping the linear motion of the grinder.

### BRIEF DESCRIPTION OF DRAWINGS

These and other features, aspects, and advantages of the present inventions will become better understood when the following detailed description is read with reference to the accompanying drawings in which like characters represent like parts throughout the drawings, wherein:

FIG. 1 is a technical drawing illustrating a grinder, in accordance with one or more embodiments of the inventions, in perspective view from a first angle;

FIG. 2 is a technical drawing illustrating the grinder of FIG. 1 in perspective view from a second angle;

FIG. 3 is a technical drawing illustrating, in elevation view, the grinder shown in FIG. 1;

FIG. 4 is a technical drawing illustrating, a first end of the grinder shown in FIG. 1;

FIG. 5 is a technical drawing illustrating, in section view along line 5-5′ shown in FIG. 3, the grinder from FIG. 1;

FIG. 6 is a technical drawing illustrating, in perspective view, a first part of a grinder in accordance with one or more embodiments of the inventions;

FIG. 7 is a technical drawing illustrating, in elevation view, the first part of the grinder shown in FIG. 6;

FIG. 8 is a technical drawing illustrating, in section view along line 8-8′ shown in FIG. 7, the first part of the grinder shown in FIG. 6;

FIG. 9 is a technical drawing illustrating, in perspective view, a first flywheel for a grinder in accordance with one or more embodiments of the inventions;

FIG. 10 is a technical drawing illustrating, in elevation view, the first flywheel shown in FIG. 9;

FIG. 11 is a technical drawing illustrating, in section view along line 11-11′ shown in FIG. 10, the first flywheel shown in FIG. 9;

FIG. 12 is a technical drawing illustrating, in exploded and partial section view, the grinder shown in FIG. 1;

FIG. 13 is a technical drawing illustrating, in perspective view, a hollow axle in accordance with one or more embodiments of the inventions;

FIG. 14 is a flow-diagram illustrating an implementation of a method of using a grinder.

### DETAILED DESCRIPTION

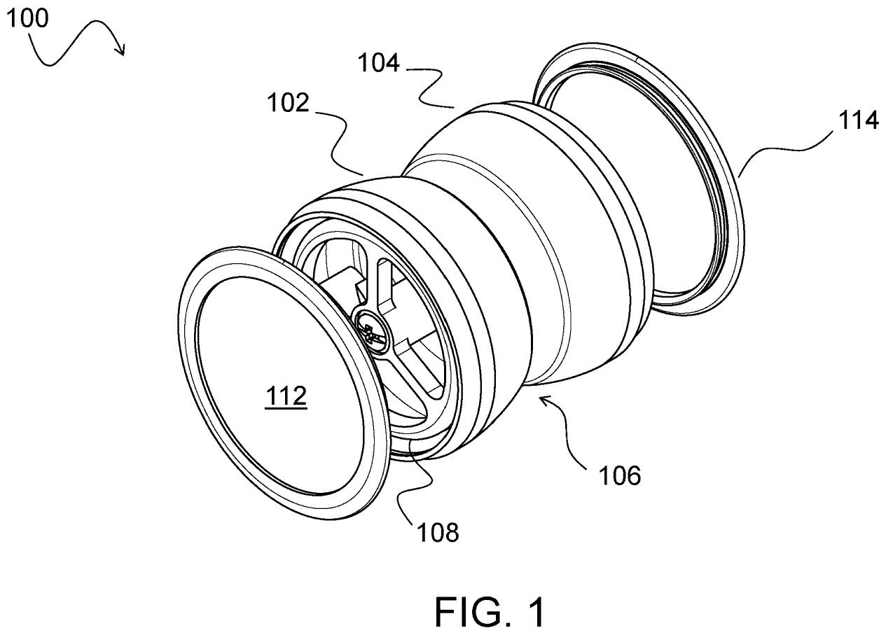

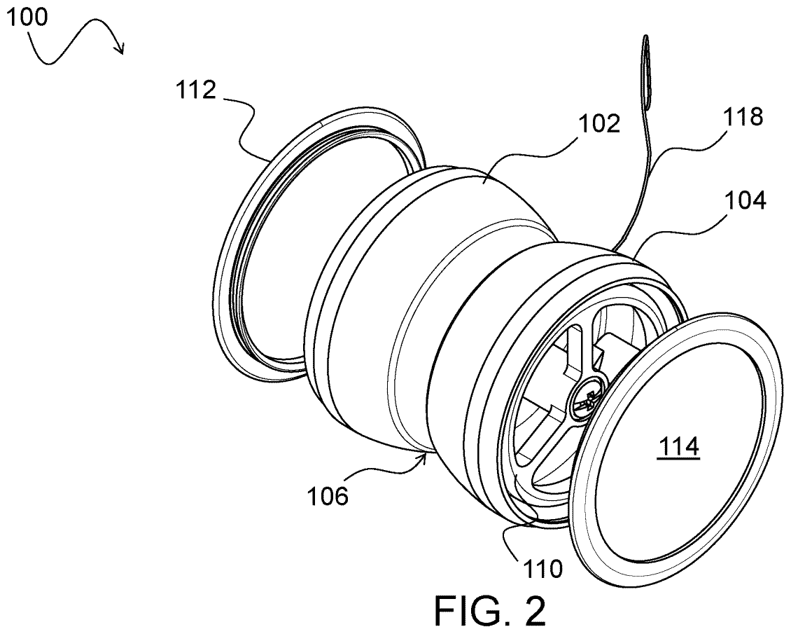

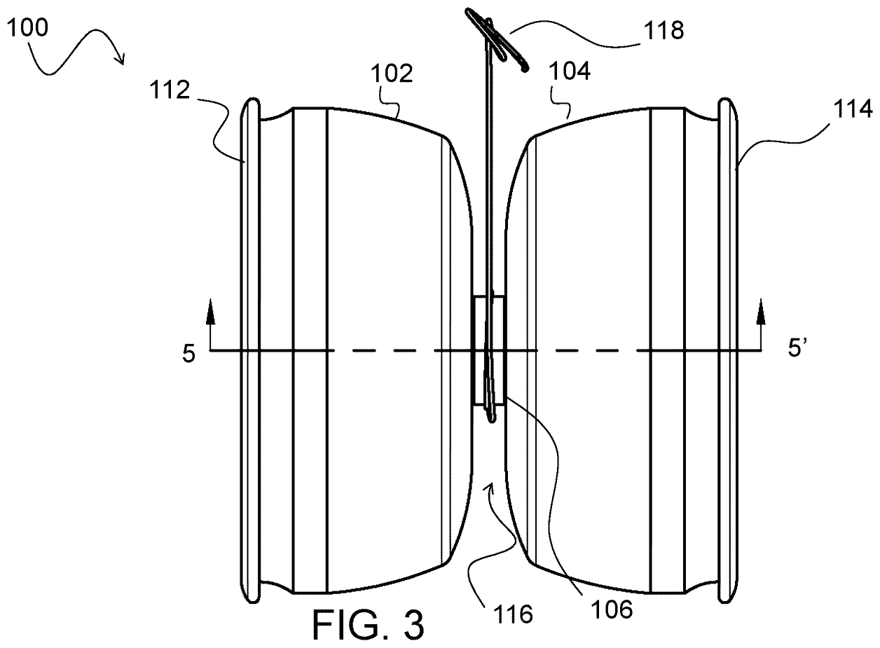

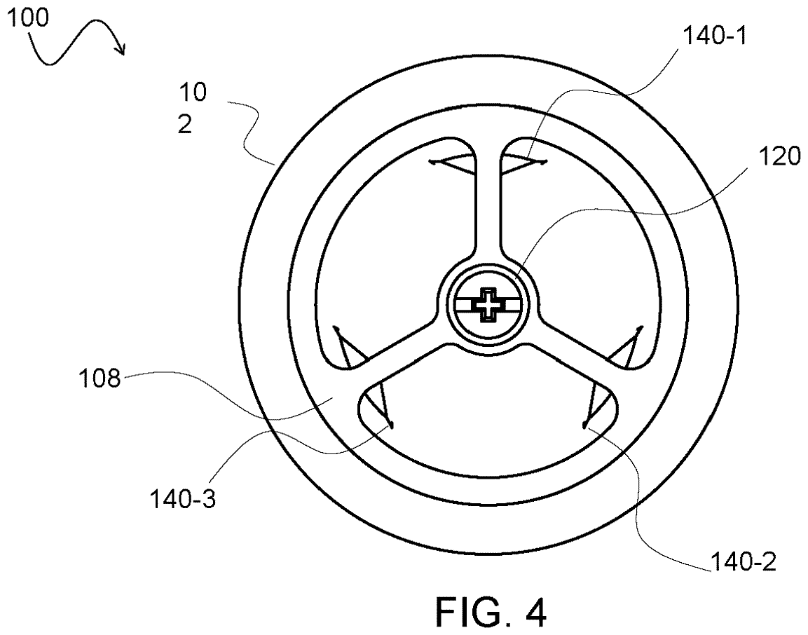

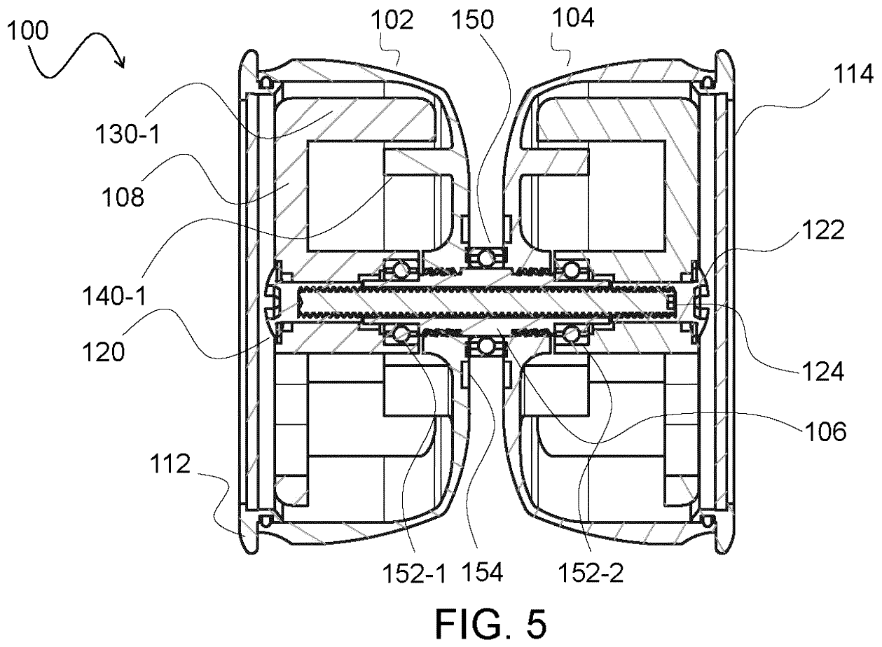

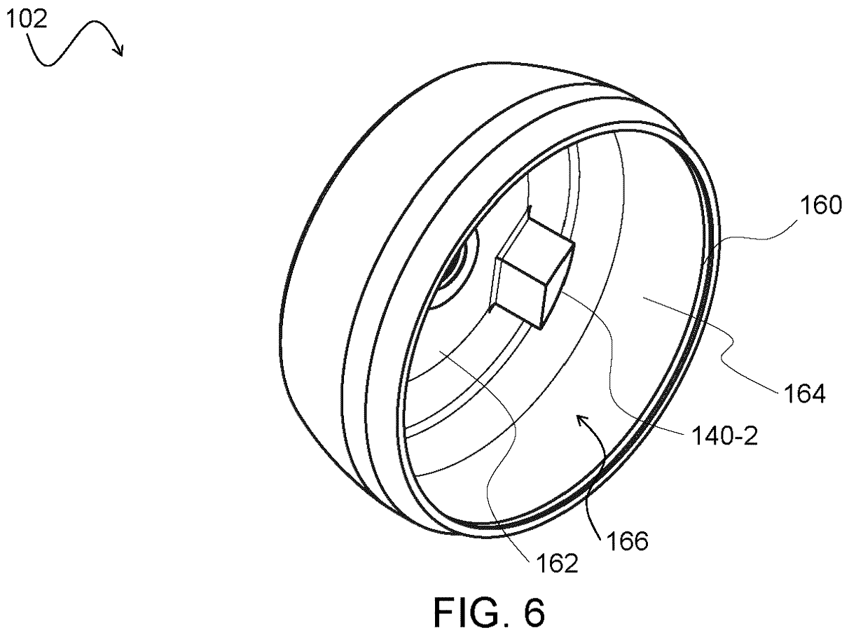

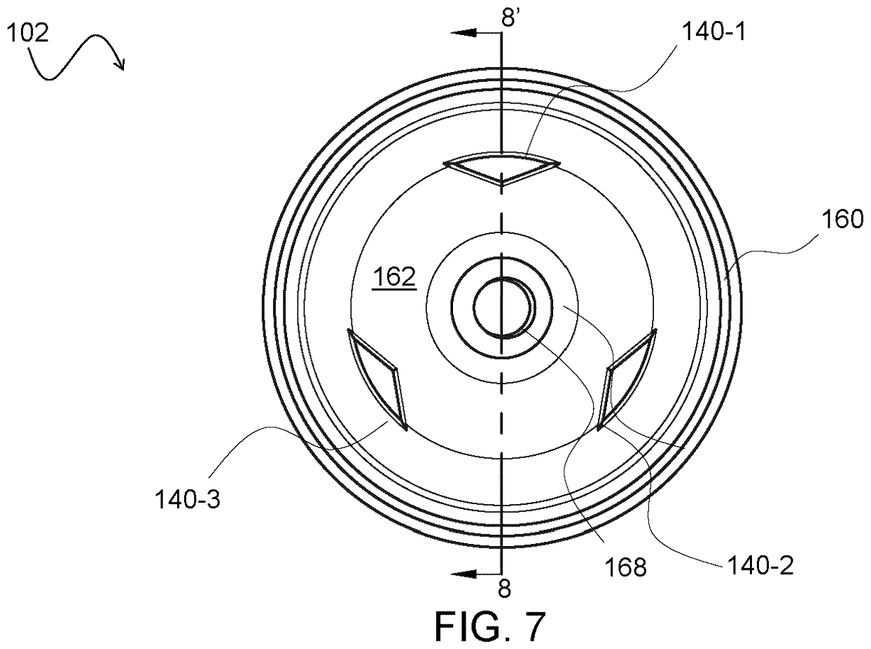

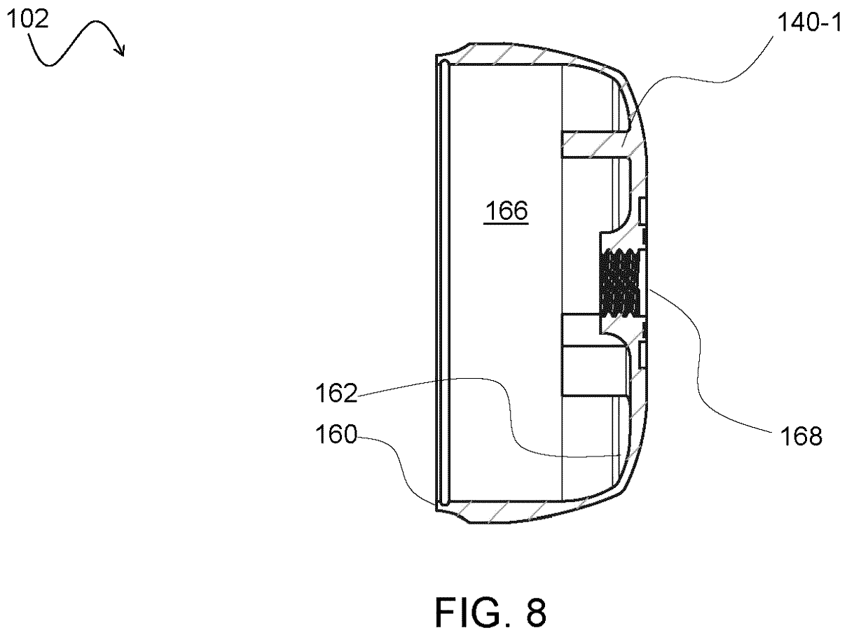

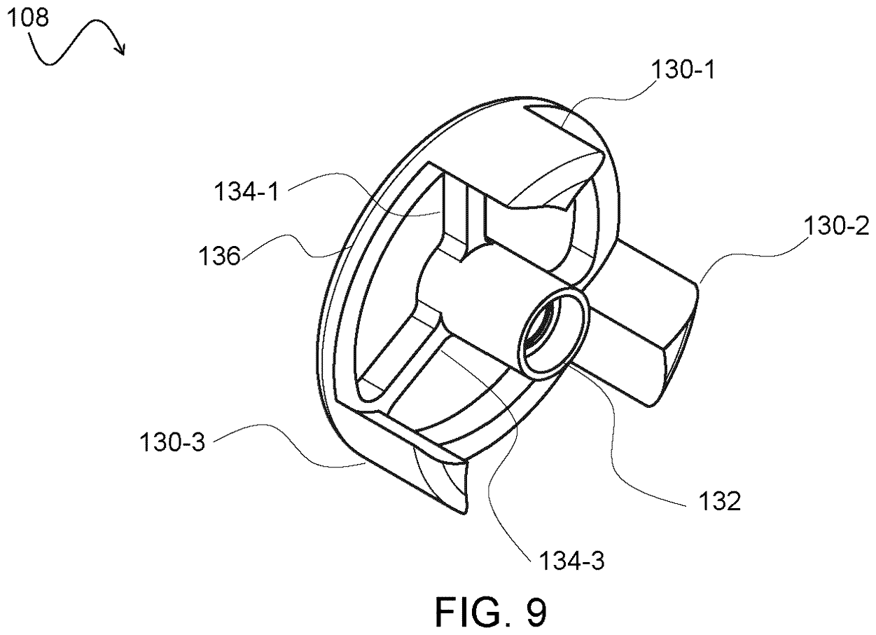

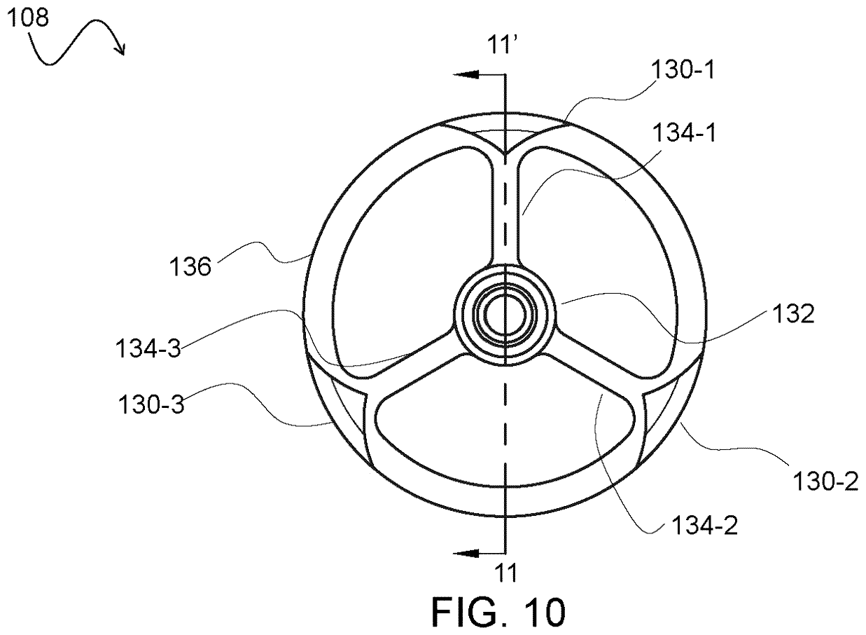

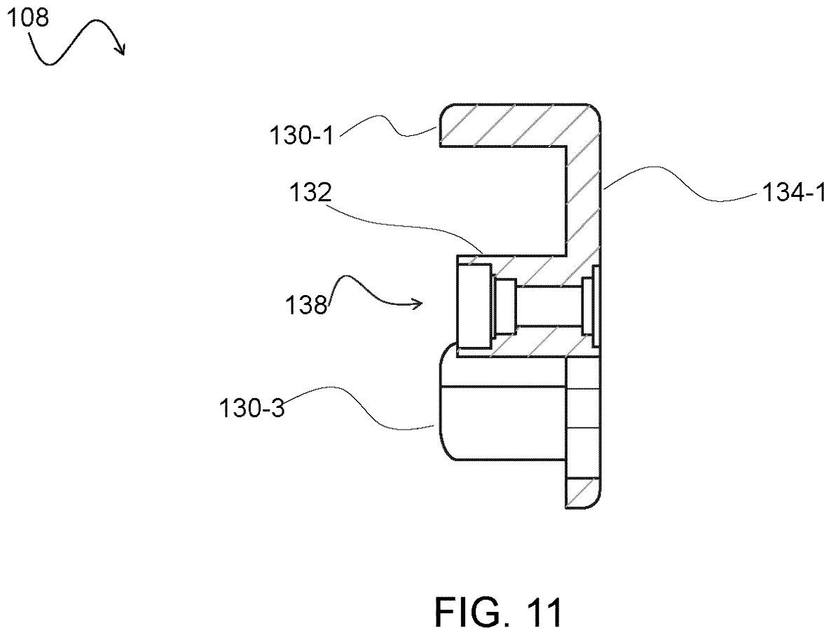

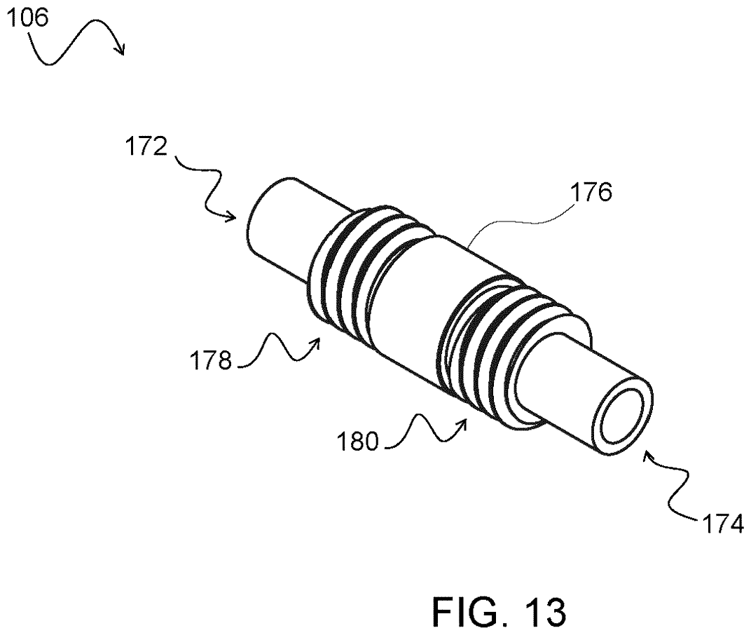

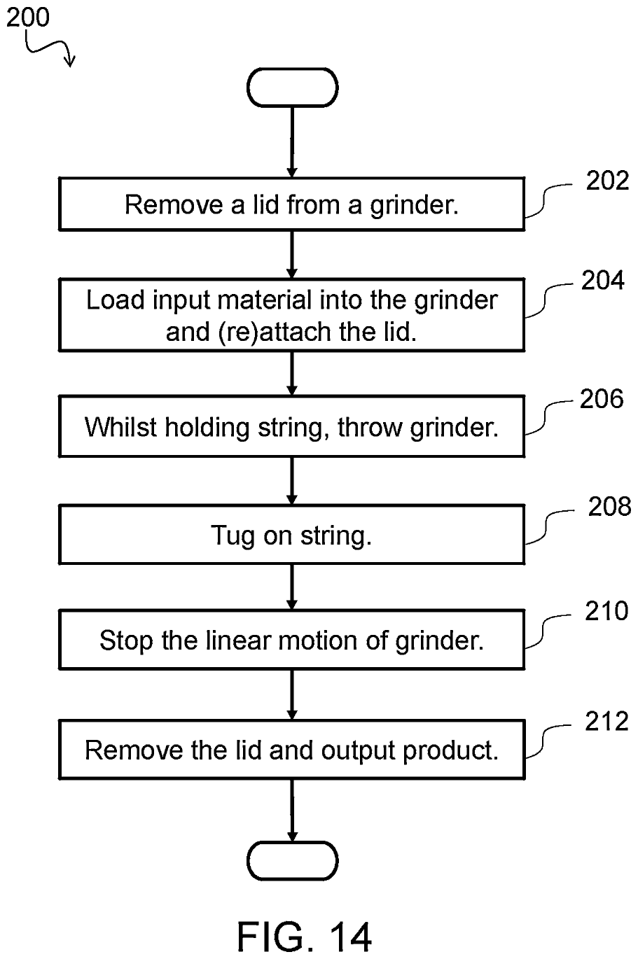

The present disclosure provides a novel device that overcomes problems with commercially available grinders. FIG. 1 and FIG. 2 illustrate a device, for example and without loss of generality, a grinder, in accordance with one or more embodiments of the inventions. FIG. 3 and FIG. 4 illustrate the grinder of FIG. 1 in elevation views respectively in side view and end view. FIG. 5 shows the grinder of FIG. 1 in section view. In some embodiments, a grinder includes a first part shown in FIG. 6, FIG. 7, and FIG. 8. In some embodiments, the first part partially encloses a first flywheel shown in FIG. 9, FIG. 10, and FIG. 11. FIG. 5 and FIG. 13 illustrate an example of a hollow axle. FIG. 14 illustrates an implementation of a method of using a grinder, such as the grinder shown in FIG. 1. In some embodiments, the device shown and described herein is a climbing top. For example, a toy including two conjoined bodies, e.g., cones or discs, with a deep groove between them in which a string is attached and wound, its free end being held so that the toy can be made to fall under its own weight and rise again by its momentum.

As used in this specification and the appended claims, the singular forms “a”, “an”, and “the” encompass embodiments having plural referents, unless the content clearly dictates otherwise. As used in this specification and the appended claims, the term “or” is generally employed in its sense including “and/or” unless the content clearly dictates otherwise.

Unless otherwise indicated, all numbers expressing feature sizes, amounts, and physical properties used in the specification and claims are to be understood as being modified in all instances by the term “about”. Accordingly, unless indicated to the contrary, the numerical parameters set forth in the foregoing specification and attached claims are approximations that can vary depending upon the desired properties sought to be obtained by those skilled in the art utilizing the teachings disclosed herein. For example, depending on the choice of a measurement technique, a length of 2 inches may include a variation of about 1%, which would indicate length may be about 1.98 inches to about 2.02 inches.

FIG. 1 illustrates the device (for example the grinder) 100 in accordance with one or more embodiments of the invention. FIG. 2 illustrates the grinder 100 from a second angle.

Grinder 100 includes a first hollow body 102, a second hollow body 104, and a hollow axle 106. Hollow axle 106 joins the first hollow body 102 and the second hollow body 104. In some embodiments, the hollow axle 106 includes a first end attached near centroid of the first hollow body 102 and a second end near the centroid of the second hollow body 104.

In some embodiments, the grinder 100 includes a first flywheel 108 placed inside the first hollow body 102. First flywheel 108 is rotatably mounted and spins relative to first hollow body 102. In some embodiments, the grinder 100 includes a second flywheel 110 placed inside the second hollow body 104. First flywheel 108 and the second flywheel 110 may be balanced. In some embodiments, the first flywheel 108 and the second flywheel 110 are coupled.

In some embodiment, the first hollow body 102 includes a first cavity as defined in part by a first edge. In some embodiments, the grinder 100 includes a first lid 112 which mates with the first edge of the first hollow body 102 to seal the first cavity. In some embodiments, the second hollow body 104 includes a second cavity as defined in part by a second edge. In some embodiments, the grinder 100 includes a second lid 114 which mates with the second edge of the second hollow body 104 to seal the second cavity. First lid 112 or Second lid 114 may be attached by interference fit or by threaded connection.

In some embodiments, the grinder 100 includes a tether or string 118 encircling hollow axle 106. In some embodiments, the string 118 includes cotton. In some embodiments, the string 118 is a material selected from the group consisting of cotton, cotton-nylon blend, cotton-polyester blend, nylon, and polyester.

Turning to FIG. 3 which illustrates an elevation view of grinder 100. Grinder 100 includes a hollow axle 106 joining the first hollow body 102 and the second hollow body 104. Each of the first hollow body 102 and second hollow body 104 includes a proximal side. The proximal sides of the first hollow body 102 and the second hollow body 104 are spaced apart to define a slot 116. Slot 116 may be sagittal plane of the grinder 100.

In some embodiments, the grinder 100 includes one or more materials selected from the group consisting of metal, plastic, and wood. In some embodiments, the grinder 100 includes aluminum, such as aluminum in the first hollow body 102, the second hollow body 104. In some embodiments, the first flywheel 108 and the second flywheel 110 include steel.

Turning to FIG. 4 which illustrates an elevation view of a first end of the grinder 100. As shown, the first end is the near end in FIG. 1. Grinder 100 includes the first flywheel 108 which is partially surrounded by the first hollow body 102. For example, the first hollow body 102 includes a cavity in which sits the first flywheel 108. In some embodiments, a bolt 120 holds the first flywheel 108 in place.

In some embodiments, the grinder 100 includes a first plurality of projections 140 located on the first hollow body 102. The first plurality of projections 140 (e.g., projection 140-1, projection 140-2, and projection 140-3) extend into the interior of the first hollow body 102. In some embodiments, the first plurality of projections 140 extend from distal surface of the proximal side of the first hollow body 102.

FIG. 5 illustrates a section view of the grinder 100. As shown, the grinder 100 has a butterfly-like profile as principally defined first hollow body 102 and second hollow body 104. First hollow axle 106 joins the first hollow body 102 and the second hollow body 104.

Coaxial with and partially enclosed by the first hollow axle 106 is a second axle 124. Second axle 124 maybe a solid axle. In some embodiments, the second axle 124 is a threaded rod. First flywheel 108 is attached to the second axle 124 by bolt 120, for example, a Chicago bolt. In some embodiments, the second flywheel 110 is attached to the second axle 124 by a second bolt 122, for example, a Chicago bolt.

In some embodiments, the grinder 100 includes one or more bearings or bushings. As shown, the grinder 100 includes a plurality of bearings. In some embodiments, grinder 100 includes a central bearing 150. Central bearing 150 includes an inner race that is connected to the first hollow axle 106. Central bearing 150 includes a plurality of balls or rollers that separate the inner race from an outer race. The outer race effectively is the outer diameter of the hollow axle.

In some embodiments, grinder 100 includes a first flywheel bearing 152-1. First flywheel bearing 152-1 includes an inner race in interference fit with the first hollow axle 106. First flywheel bearing 152-1 includes a plurality of rollers or balls overlying the inner race. First flywheel bearing 152-1 includes an outer race overlying the rollers or balls, and in interference fit with the first flywheel 108.

In some embodiments, grinder 100 includes a second flywheel bearing 152-2.

Central bearing 150 allows the grinder 100 to maintain rotational momentum when hanging from the string 118.

In some embodiments, grinder 100 includes one or more high-friction areas, e.g., area 154. The one or more high-friction areas may be placed on the proximal surface of the proximal sides of hollow bodies, e.g., first hollow body 102 and second hollow body 104. In some embodiments, area 154 is treated or covered to provide more friction. For example, covered in textured in manufacturing or coated silicone. Area 154 bites into string 118 to induce the gyroscope to climb conserving rotational momentum for grinding.

Turning to FIG. 6 which illustrates the first hollow body 102 in accordance with some embodiments of the invention. In some embodiments, the first hollow body 102 includes a first edge 160, a proximal side including a distal surface 162, and an inner surface 164, which defines a first cavity 166.

In some embodiments, the grinder 100 includes the first plurality of projections 140 located on the first hollow body 102. The first plurality of projections 140 (e.g., projection 140-2) extends into first cavity 166. In some embodiments, the first plurality of projections 140 extend from the distal surface 162.

FIG. 7 illustrates an elevation view of the first hollow body 102 in accordance with some embodiments. In some embodiments, the first hollow body 102 includes the first plurality of projections 140 (e.g., projection 140-1, projection 140-2, and projection 140-3) extending into first cavity 166. In some embodiments, first hollow body 102 includes a void 168 to receive one or more axles. For example, the void 168 may receive a first hollow axle.

FIG. 8 illustrates a section view of first hollow body 102 in accordance with some embodiments. In the shown embodiment, the first hollow body 102 includes the projection 140-1 extending from the distal surface 162 into the first cavity 166. In some embodiments, a void 168 is threaded.

Turning to FIG. 9 which illustrates the first flywheel 108 in accordance with some embodiments of the invention. In some embodiment, the first flywheel 108 includes the second plurality of projections 130 (e.g., projection 130-1, projection 130-2, and projection 130-3). In some embodiments, projections in the second plurality of projections 130 are spaced evenly apart.

In some embodiments, the second plurality of projections 130 is affixed to the first flywheel 108 and extends away from the first flywheel 108. In some embodiments, the second plurality of projections 130 extends in an axial direction. The second plurality of projections 130 may extend towards the first plurality of projections 140. First plurality of projections 140 and the second plurality of projections 130 are spaced (e.g., radially separated) such that the relative rotational motion of the first hollow body 102 and the first flywheel 108 allow the first plurality of projections 140 and the second plurality of projections 130 to move freely. For example, parts of the projections move past but do not interfere with other projections. First plurality of projections 140 and the second plurality of projections 130 are axially spaced (e.g., axially overlapping) such that in the relative rotational motion of the first hollow body 102 and the first flywheel 108 material in the first hollow body 102 is cut, ground, or shredded by one or more projections in the first plurality of projections 140 and the second plurality of projections 130.

In some embodiments, the first flywheel 108 includes a hub 132, a plurality of spokes 134 extending from the hub 132, and an outer mass, such as an annulus 136. The outer mass is coupled to the hub 132 through plurality of spokes 134. Outer mass provides increased rotational inertia for first flywheel 108.

FIG. 10 illustrates the first flywheel 108 in elevation view. As shown in the illustrated embodiment, plurality of spokes 134 includes spoke 134-1, spoke 134-2, and spoke 134-3. As shown in the illustrated embodiment, the second plurality of projections 130 includes a projection with a triangular profile. In some embodiments, the profile of a projection in the second plurality of projections 130 includes a projection with a shape selected from the group consisting of concaved hull, gibbous, lozenge, rectangle, rhomboid, rhombus, square, tear dropped, triangle, and wedge.

FIG. 11 illustrates the first flywheel 108 in section view along the line 10-10′ included in FIG. 10. In some embodiments, the first flywheel 108 includes a void 138 to receive one or more axles.

In some embodiments, the second flywheel 110 is a mirrored counterpart to first flywheel 108. In some embodiments, aspects of the second flywheel 110 are reversed such as thread direction. In some embodiments, the second flywheel 110 balances the first flywheel 108 but does not include a plurality of projections. In some embodiments, the first flywheel 108 and the second flywheel 110 include a metal selected from the group consisting of aluminum, brass, and steel.

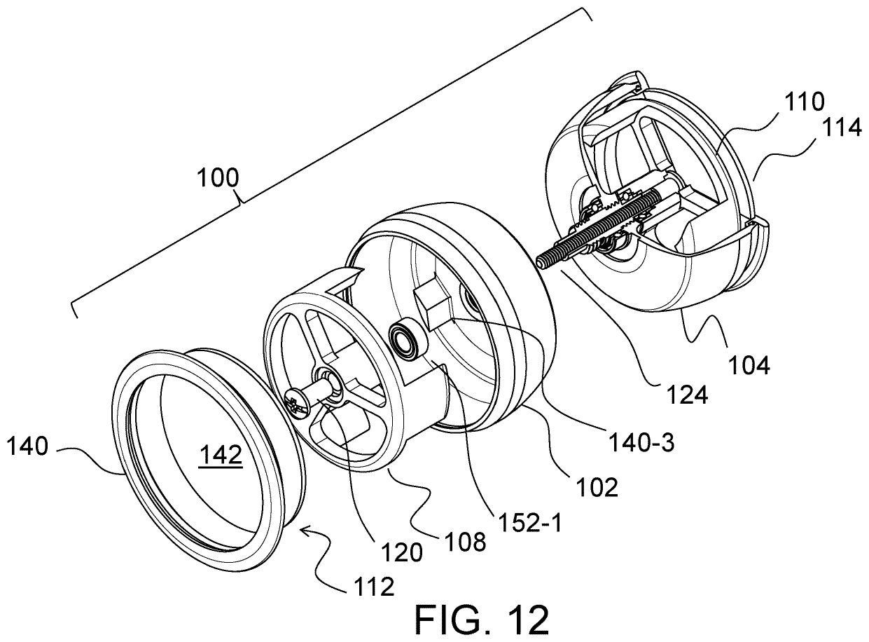

FIG. 12 illustrates an exploded and partial section view of the grinder 100. In some embodiments, first lid 112 includes a rim 190 and a blank 192. For example, the rim 190 may include a deformable gasket, and blank 192 a plastic sheet, e.g., translucent plastic.

FIG. 13 illustrates a detailed view of an example of first hollow axle 106. First hollow axle 106 includes a first end 172, a second end 174, and a central region (e.g., windlass). In some embodiments, the first hollow axle 106 includes a first thread region 178 and a second threaded region 180. In some embodiments, the first hollow axle 106 is treated or covered to provide more friction. For example, covered in silicone or textured in manufacturing. A grippier central region 176 bites into string 118.

Turning to FIG. 14 which illustrates an example of method 200 for use with a grinder such as grinder 100. Grinder 100 may be used to grind various input materials including cannabis, spice, tobacco, or tea. Method 200 may be performed by a user, e.g., cook, herbalist, pharmacist, processor, smoker, or torcedores/torcedoras. Method 200 can be performed on either the grinder 100 or the climbing top.

For method 200, as with other methods taught herein, the various acts may be performed in a different order than that illustrated and described. Additionally, the methods can omit some acts, combine acts, split an act, and/or employ additional acts. In some implementations, the methods can repeat acts, repeat acts in different order, or the like.

Method 200 begins at 202 when the user removes a lid from the grinder 100. For example, the user removes lid 112 from the grinder 100. In some implementations, the grinder 100 is presented to the user with a lid detached.

At 204, the user loads input material into the grinder 100 and (re) attaches the lid. For example, the user loads a raw material for grinding, such as cannabis, incense, spice, tobacco, or tea. In some implementations, the user loads input material into the cavity 166 of the first hollow body 102. The user re-attaches the lid to the grinder 100 so the material inside is not lost in operation.

At 206, whilst holding the string, the user throws the grinder 100. For example, whilst holding a part of the string 118 the user drops grinder 100. The grinder 100 including at least one flywheel moves linearly and rotationally but with little rotational movement of the at least one flywheel relative to at least one hollow body.

At 208, the user tugs on the string 118. Grinder 100 includes an axle attached to the string 118. The axle provides a purchase for the string 118 and winds up along the string 118. In some implementations, the user does not tug on string 118.

At 210, the user stops the linear motion of the grinder 100. For example, the user catches the grinder 100. The user may allow the grinder 100 to make contact with a solid body. The at least one flywheel will be set in relative motion providing the energy for the grinder 100. In alternative phrasing, the user starts the at least one flywheel spinning.

A user may repeat one or more acts in method 200. For example, repeat act 206, act 208, and act 210.

At 212, the user removes the lid and the output product. The output product is ground material.

While only certain features of the invention have been illustrated and described herein, those skilled in the art will recognize many changes or modifications are possible for the disclosed embodiments or implementations. It is, therefore, to be understood that the appended claims are intended to cover all such modifications and changes as fall within the true spirit of the invention.

1. A device comprising:
a first hollow body;
a second hollow body;
a first hollow axle joining the first hollow body and the second hollow body;
a second axle coaxial with and in slip-fit engagement with the first hollow axle;
a first flywheel connected to the solid axle and placed in the first hollow body; and
a second flywheel connected to the solid axle and placed in the second hollow body.

2. The device of claim 1 further comprising a string encircling the hollow axle.

3. The device of claim 1 further comprising a first plurality of projections located on the first hollow body and extending into the interior of the first hollow body.

4. The device of claim 3, wherein the first hollow body includes a proximal side and the first plurality of projections are spaced apart on the interior of the proximal side of the first hollow body.

5. The device of claim 3 further comprising a second plurality of projections affixed to the first flywheel and extending away from the first flywheel, wherein in the relative rotational motion of the first flywheel and the first hollow body, the first plurality of projections and the second plurality of projections move freely.

6. The device of claim 1, wherein the first hollow body includes a distal side, an opening on the distal side of the first hollow body, and the device further comprises a first cap to seal the distal opening.

7. The device of claim 1 further comprising:
an inner race in an interference fit with the solid axel,
an outer race in an interference fit with the hollow axle, and
a plurality of bearings between the inner race and the outer race.

8. The device of claim 1 further comprising a detachable lid and coupled to a string.

9. The device of claim 1 is a grinder.

10. The device of claim 1 is a climbing top.

11. A method for operation of a grinder including a detachable lid and coupled to a string, the method comprising:
loading an input material into the grinder;
attaching the detachable lid;
throwing the grinder while holding the string;
tugging on the string; and
stopping the linear motion of the grinder.

12. The method of claim 11 further comprising removing the detachable lid from the grinder.

13. The method of claim 12 further comprising unloading the grinder.

14. The method of claim 11, wherein stopping the linear motion of the grinder further comprises, catching the grinder or allowing the grinder to make contact with a solid body.
